(19) United States
(12) Patent Application Publication
(10) Pub. No.: US 2012/0050688 A1
(43) Pub. Date: Mar. 1, 2012

(54) FABRICATION SYSTEM HAVING TEMPLATE PROJECTION

(76) Inventors: TayChang Wu, Detroit, MI (US); Michael H. Noble, Dunlap, IL (US); Eric R. Larsen, Peoria, IL (US); Keith A. Herman, Peoria, IL (US); Keith M. Egland, Peoria, IL (US); Chee K. Ng, Dunlap, IL (US)

(21) Appl. No.: 12/894,961

(22) Filed: Sep. 30, 2010

Related U.S. Application Data
(60) Provisional application No. 61/379,174, filed on Sep. 1, 2010.

(51) Int. Cl. G03B 21/26

(52) U.S. Cl. 353/28; 353/121

(57) ABSTRACT

A fabrication system is disclosed. The fabrication system may have a work surface configured to support a base component, and an image projector. The image projector may be configured to project onto the base component a first image corresponding to an existing feature of the base component, and to project onto the base component a second image corresponding to a feature to be fabricated.

### RELATED APPLICATIONS

This application is based on and claims the benefit of priority from U.S. Provisional Application No. 61/379,174 by TayChang W U et al., filed Sep. 1, 2010, the contents of which are expressly incorporated herein by reference.

### TECHNICAL FIELD

The present disclosure relates generally to a fabrication system, and more particularly, to a fabrication system having template projection.

### BACKGROUND

Some manufacturers utilize templates during component fabrication to determine the location of features to be added, material to be removed, surfaces to be treatment, etc. Templates have historically embodied physical patterns or frames that include openings or protrusions at specified locations. When the templates are placed over a base component or stock material, the openings or protrusions guide the desired fabrication process. By continually using the same template for a particular fabrication process, accuracy and repeatability in the process can be achieved.

Although suitable for some applications, physical templates can also be expensive and difficult to use in other applications. In particular, each time a design change to the fabricated component is made, similar changes to the template must also be made. In some situations, the design changes may be significant enough to require completely new templates. Each time a template is changed or replaced, a fabrication cost of the component assembly increases. In addition, the templates can wear, warp, or be damaged during the fabrication process and subsequently introduce error in the placement of features. Further, the templates are generally created based on a theoretical model of a final component assembly that does not always match actual component geometry.

One attempt to reduce the expense and difficulty associated with physical templates used in a fabrication process is disclosed in U.S. Pat. No. 4,739,487 issued to Bonnet et al. on Apr. 19, 1988 (“the '487 patent”). Specifically, the '487 patent discloses a cutting system for use in the leather or textile industry. The cutting system includes a computer having stored therein templates that can be projected onto a base material, for example leather used in shoe fabrication. After the templates are projected onto the base material, an operator observes the location of the templates and moves the templates around on the base material via a mouse or light pen so as to minimize loss of the base material or to avoid flaws in the base material. After the templates are arranged as desired, the computer identifies the location of the templates relative to the base material and then guides a laser or fluid-jet cutting machine to cut through the base material in the outline of the templates.

Although the cutting system of the '487 patent may avoid some of the disadvantages associated with physical templating in the leather or textile industry, it may lack applicability to other industries. For example, the templates of the '487 patent are not required to be precisely located relative to existing features of the base material. Accordingly, the cutting system of the '487 provides no such capability. In addition, the mouse or light pen utilized in the '487 patent to move the projected templates may be difficult to grasp by operators clothed in protective equipment such as welding gloves.

The disclosed fabrication system is directed to overcoming one or more of the problems set forth above and/or other problems of the prior art.

### SUMMARY

In one aspect, the present disclosure is directed to a fabrication system. The fabrication system may include a work surface configured to support a base component, and an image projector. The image projector may be configured to project onto the base component a first image corresponding to an existing feature of the base component, and to project onto the base component a second image corresponding to a feature to be fabricated.

In another aspect, the present disclosure is directed to a method of fabricating a component assembly. The method may include projecting onto a base component a first image corresponding to an existing feature of the base component, and projecting onto the base component a second image corresponding to a feature to be fabricated.

### BRIEF DESCRIPTION OF THE DRAWINGS

FIG. 1 is a schematic illustration of an exemplary disclosed fabrication system; and

FIG. 2 is an exemplary disclosed pattern projected by the fabrication system onto a component to be fabricated.

### DETAILED DESCRIPTION

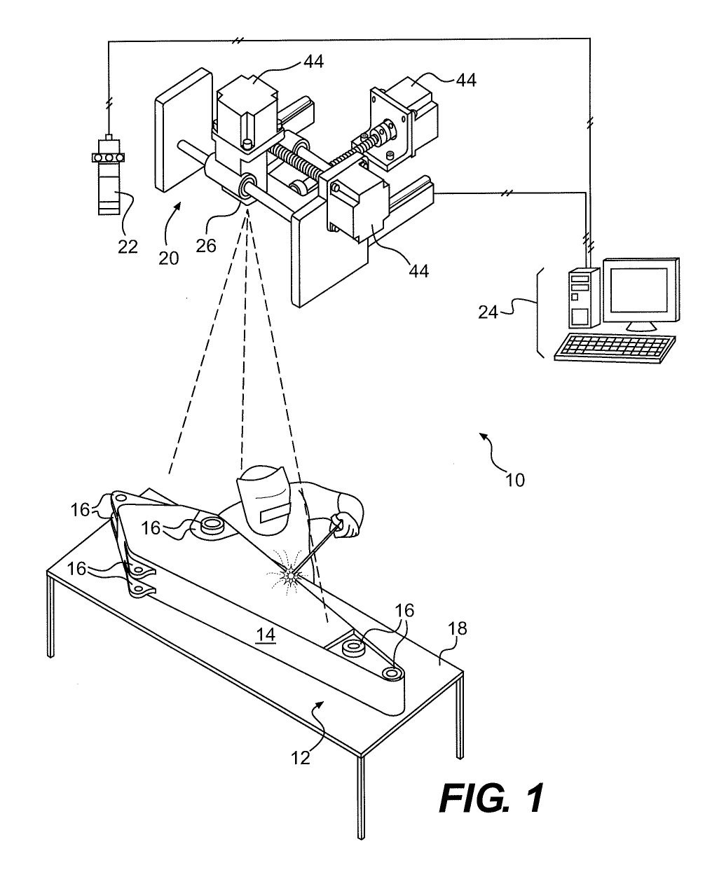

FIG. 1 illustrates a fabrication system 10. Fabrication system 10 may be used to fabricate different component assemblies 12 for a wide range of industries. These industries may include, for example, mining, construction, farming, power generation, transportation, or any other industry known in the art. In the disclosed embodiment, component assembly 12 is a metallic excavator arm that includes a base component 14 and a plurality of features 16 added to or created within base component 14. Features 16 may include, among other things, bosses, flanges, plates, clips, fasteners, shoes, channels, holes, recesses, etc. Features 16 may be added to base component 14 via welding, chemical adhesion, or another similar process; or created within base component 14 via cutting, drilling, ablation, etching, or another known process. It should be noted that, although a metallic component assembly 12 is shown and described throughout this disclosure, component assembly 12 may be fabricated from any material using fabrication system 10. Fabrication system 10 may include a work surface 18, an image projector 20, a sensor 22, and a controller 24 in communication with image projector 20 and sensor 22.

Work surface 18 may include any support structure that adequately holds base component 14 during fabrication of features 16. In one embodiment, work surface 18 may be a table or frame configured to support base component 14 from an underside (not shown). In another embodiment, work surface 18 may be a rack that hangs from a shop ceiling to suspend base component 14 at a desired location above the ground. It is contemplated that work surface 18 may include devices for securing base component 14 in place, for example mechanical and/or magnetic clamps (not shown). Work surface 18 may be stationary or movable, as desired.

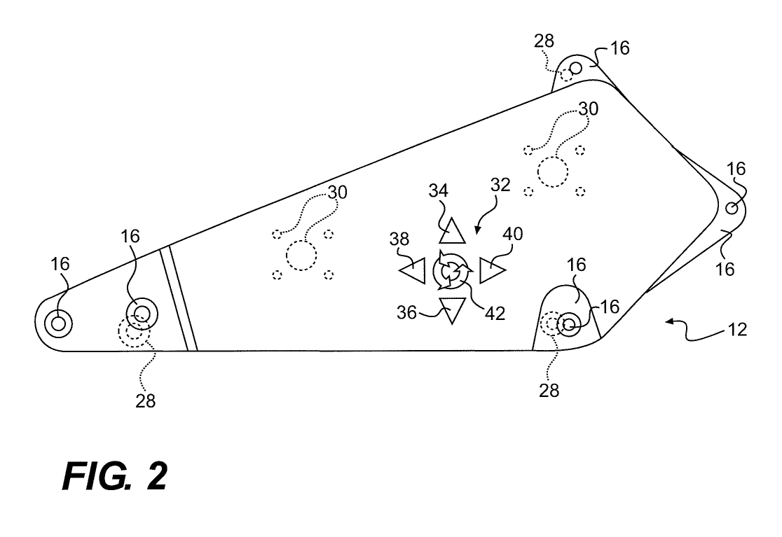

Image projector 20 may be configured to project multiple images onto a surface of base component 14. In particular, image projector 20 may be located to one side of base component 14, opposite work surface 18, and include a projection device 26 oriented in the general direction of base component 14. Projection device 26 may be selectively controlled to project a plurality of images onto an exposed surface of base component 14 at precise locations. As shown in FIG. 2, the images projected by projection device 26 may include, among other things, a reference image 28, a feature location indicator 30, and an interface image 32. Projection device 26 may embody any type of image projector known in the art such as, for example, a laser projector.

Reference image 28 may correspond with an existing feature 16 of base component 14. For example, reference image 28 may resemble at least a portion of the existing feature 16 already fabricated within base component 14 such as an edge, a surface, or a hole. Reference image 28 may be a solid or dashed outline of the existing feature 16 that is projected onto base component 14 in the vicinity of the existing feature 16.

Feature location indicator 30 may correspond with a desired location of a feature 16 to be added to or created within base component 14. For example, feature location indicator 30 may resemble a target symbol such as an “X” or a series of concentric rings. Alternatively, feature location indicator 30 may resemble a portion of the actual feature 16 to be added such as an edge, a surface, or a hole. Feature location indicator 30 may be portrayed in solid or dashed lines and projected onto base component 14 at a desired fabrication location where the feature 16 is to be added.

Interface image 32 may include one or more symbols associated with desired movements of reference image 28 and feature location indicator 30. For example, interface image 32 may include translation symbols such as a fore symbol 34, an aft symbol 36, a left symbol 38, and a right symbol 40. Interface image 32 may also include a rotation symbol 42. It is contemplated that interface image 32 may include different and/or additional symbols than described above such as zoom-in and zoom-out symbols, if desired. When an operator interfaces with one of symbols 34-42 projected onto the surface of base component 14, the operator is indicating a corresponding desired movement of reference image 28 and feature location indicator 30 relative to base component 14. The operator may interface with symbols 34-42 by touching the vicinity of a particular projected symbol 34-42 or by moving a reflective, magnetic, illuminated, or other pointing device to the vicinity of the particular symbol 34-42.

The placement of images 28-32 on base component 14 may be adjustable and achieved in a number of different ways. That is, the location of reference image 28, feature location indicator 30, and interface image 32 on base component 14 may be translated in the fore/aft and left/right directions, and/or rotated relative to base component 14. In the depicted embodiment, image projector 20 includes multiple actuators 44 connected in a gantry arrangement to physically move projection device 26 in response to different command signals, thereby translating and/or rotating images 28-32. In another embodiment (not shown), work surface 18 may be similarly equipped with one or more actuators that move base component 14 relative to projection device 26 in response to different command signals. In yet another embodiment (not shown), images 28-32 may be digitally, electronically, or otherwise translated and/or rotated within projection device 26 without any physical movement of projection device 26 or work surface 18.

Sensor 22 may be associated with fabrication system 10 to detect the movements of the operator that indicate a desired movement of reference image 28 and/or feature location indicator 30. Sensor 22 may embody, for example, a camera, a lidar sensor, a radar sensor, a light sensor, a magnetic sensor, or another similar sensor configured to detect motion of the operator's hand or pointing device relative to interface image 32. Sensor 22 may mounted over base component 14 (i.e., near or with image projector 12), or near or under mounting surface 18. When the operator's hand or point device is moved to the vicinity of one of the projected symbols 34-42, sensor 22 may detect the movement and generate a corresponding signal directed to controller 24.

Controller 24 may be in communication with sensor 22 and with image projector 20 to control placement of projected images 28-32 on base component 14 in response to the signal from sensor 22. Controller 24 may embody a single or multiple microprocessors, field programmable gate arrays (FPGAs), digital signal processors (DSPs), etc. that include a means for controlling an operation of fabrication system 10 in response to the input. After an initial projection of images 28-32 onto base component 14, an operator may observe that reference image(s) 28 does not align as desired with the existing features 16 of base component 14. Accordingly, the operator may choose to move images 28-32 relative to base component 14 and place a hand or other point device in the vicinity of one of symbols 34-42. Sensor 22 may detect the operator's movements and generate corresponding signals directed to controller 24. In response to the signals, controller 24 may cause images 28-32 to move relative to base component 14. For example, controller 24 may selectively energize actuators 44 to translate and/or rotate projection device 26 relative to base component 14, thereby also moving images 28-32. Alternatively, controller 24 may selectively energize actuators associated with work surface 18 or cause the images to be digitally adjusted within projection device 26.

The initial images projected onto base component 14 may also be regulated by controller 24. In particular, controller may have stored in memory multiple templates that each include different sets of images 28-32. Based on the particular base component 14 undergoing fabrication and/or based on a particular stage in the fabrication process, controller 24 may select a specific template for display by projection device 26. The projection location of the selected template may be defined by controller 24 based on known positions of base component 14 and projection device 26, and then subsequently adjusted based on operator input. Additionally or alternatively, feature detection of base component 14 may be utilized, as is known in the art, to set the initial projection location, if desired.

### INDUSTRIAL APPLICABILITY

The disclosed fabrication system may be utilized to fabricate any assembly of components where templating is beneficial. The disclosed fabrication system may provide for virtual templating that is operator adjustable based on an observed deviation in projection placement. Operation of fabrication system 10 will now be described.

As detailed above, an initial projection of images 28-32 may be displayed on the exposed surface of base component 14. The particular set of images displayed may be based on the specific base component being fabricated and/or based on a stage of fabrication. For example, a first set of features 16 may require or benefit from fabrication before a second set of features 16. Accordingly, controller 24 may be programmed or otherwise instructed to select a first virtual template containing images associated with the first set of features for initial display. Controller 24 may then, based on estimated, detected, or known positions of base component 14 and projection device 26, cause the selected images to be projected onto base component 14.

After an initial projection of images 28-32 onto base component 14, an operator may observe that reference image(s) 28 does not align as desired with existing features 16 of base component 14. This situation is shown in FIG. 2, where the lower-left and lower-right features 16 do not align perfectly with the projected reference images 28. This misalignment could be caused by warping or other distortions of base component 14 introduced during previous fabrication processes, errors in locating base component 14 and/or projection device 26, computer model errors, or by other similar factors. If unaccounted for, this misalignment could result in not-yet-fabricated features 16 being located in undesired positions. Accordingly, the operator may choose to move images 28-32 and thereby improve alignment between reference images 28 and the existing features 16.

To move images 28-32, the operator may place a hand or other point device in the vicinity of one of symbols 34-42 that have been projected onto base component 14. Sensor 22 may detect the operator's movements and/or pointer position and generate corresponding signals directed to controller 24. In response to the signals, controller 24 may cause images 28-32 to move in the direction desired by the operator. Once the operator is satisfied with the observed alignment between reference image 28 and the existing features 16, the operator may proceed to fabricate new features 16 where feature location indicator 30 is projected. After fabrication of the new feature 16, the operator may cause a new template to be projected onto base component 14, and the process may be repeated.

The disclosed fabrication system may provide for precise template locating. That is, by projecting a reference image onto the base component undergoing fabrication, an operator of the disclosed fabrication system may be able to observe improper alignment between the projected images and the base component. Based on this observation, the operator may be able to make adjustments to the projected images such that a more desirable alignment may be obtained before new features are fabricated. This improved alignment may improve the likelihood of the new features being located properly.

The disclosed fabrication system may also provide for easy use by operators clothed in protective equipment. Specifically, a gloved-hand of a welder or similarly equipped fabricator may control projection movements simply with the wave of a hand. This ability may allow for simplified control without the operator having to remove equipment, thereby reducing time and effort in the fabrication process.

It will be apparent to those skilled in the art that various modifications and variations can be made to the disclosed system and method without departing from the scope of the disclosure. Other embodiments of the disclosed system and method will be apparent to those skilled in the art from consideration of the specification and practice of the system and method disclosed herein. It is intended that the specification and examples be considered as exemplary only, with a true scope of the disclosure being indicated by the following claims and their equivalents.

What is claimed is:

1. A fabrication system, comprising:
a work surface configured to support a base component; and
an image projector configured to:
project onto the base component a first image corresponding to an existing feature of the base component; and
project onto the base component a second image corresponding to a feature to be fabricated.

2. The fabrication system of claim 1, wherein the first image resembles at least a portion of the existing feature.

3. The fabrication system of claim 2, wherein the second image is a location indicator for the feature to be fabricated.

4. The fabrication system of claim 3, wherein the feature to be fabricated is a component to be joined to the base component at a projection location of the second image.

5. The fabrication system of claim 1, wherein the image projector is further configured to project an interface image onto the base component that is associated with a desired movement of the first and second images relative to the base component.

6. The fabrication system of claim 5, further including a sensor configured to detect operator movement relative to the interface image and generate a corresponding signal.

7. The fabrication system of claim 6, further including a controller in communication with the sensor and the image projector, the controller configured to affect projection of the first and second images by the image projector relative to the base component based on the signal.

8. The fabrication system of claim 7, wherein the interface image includes at least one symbol associated with a desired translation of the first and second images.

9. The fabrication system of claim 8, wherein the interface image further includes a symbol associated with a desired rotation of the first and second images.

10. The fabrication system of claim 7, wherein the controller includes a plurality of templates stored in memory, each of the plurality of templates including a different set of the first and second images.

11. The fabrication system of claim 1, wherein the image projector is a laser image projector.

12. A method of fabricating a component assembly, comprising:
projecting onto a base component a first image corresponding to an existing feature of the base component; and
projecting onto the base component a second image corresponding to a feature to be fabricated.

13. The method of claim 12, wherein the first image resembles at least a portion of the existing feature.

14. The method of claim 13, wherein the second image is a location indicator for the feature to be fabricated.

15. The method of claim 14, wherein the feature to be fabricated is a component to be joined to the base component at a projection location of the second image.

16. The method of claim 12, further including projecting onto the base component an interface image that is associated with a desired movement of the first and second images relative to the base component.

17. The method of claim 16, further including:
detecting operator movement relative to the interface image; and
affecting projection of the first and second images relative to the base component based on the signal.

18. The method of claim 16, wherein the interface image includes at least one symbol associated with a desired translation of the first and second images.

19. The method of claim 18, wherein the interface image further includes a symbol associated with a desired rotation of the first and second images.

20. A fabrication system, comprising:
a work surface configured to support a base component;
an image projector configured to:
project onto the base component a reference image resembling an existing feature of the base component;
project onto the base component a location indicator of a feature to be joined to the base component; and
project onto the base component an interface image associated with a desired movement of the reference image and the location indicator relative to the base component;
a sensor configured to detect operator movement relative to the interface image and generate a corresponding signal; and
a controller in communication with the sensor and the image projector, the controller configured to move projection of the reference image and the location indicator on the base component based on the signal.
